(19) United States
(12) Patent Application Publication
(10) Pub. No.: US 2025/0140928 A1
(43) Pub. Date: May 1, 2025

(54) LITHIUM ION BATTERY

(71) Applicant: TOYOTA JIDOSHA KABUSHIKI KAISHA, Toyota-shi Aichi-ken (JP)

(72) Inventors: Akira KOHYAMA, Toyoake-shi Aichi-ken (JP); Hiroshi IWATA, Kariya-shi Aichi-ken (JP)

(73) Assignee: TOYOTA JIDOSHA KABUSHIKI KAISHA, Toyota-shi Aichi-ken (JP)

(21) Appl. No.: 18/781,308

(22) Filed: Jul. 23, 2024

(30) Foreign Application Priority Data
Nov. 1, 2023 (JP) 2023-187544

(51) Int. Cl. H01M 10/0569; H01M 4/505; H01M 4/525; H01M 4/587; H01M 10/0525

(52) U.S. Cl. CPC H01M 10/0569; H01M 4/505; H01M 4/525; H01M 4/587; H01M 10/0525; H01M 2300/0028

(57) ABSTRACT

The lithium ion battery includes a positive electrode, a negative electrode, and an electrolytic solution. The positive electrode includes a positive electrode mixture. The positive electrode mixture contains a positive electrode active material and active lithium. A mass fraction of the active lithium with respect to a total of the positive electrode active material and the active lithium is 0.25% or more. The electrolytic solution contains a solvent and a lithium salt. The solvent contains a carboxylic acid ester in a volume fraction of 40% or more.

### CROSS-REFERENCE TO RELATED APPLICATION

This application claims priority to Japanese Patent Application No. 2023-187544 filed on Nov. 1, 2023, incorporated herein by reference in its entirety.

### BACKGROUND

### 1. Technical Field

The present disclosure relates to a lithium ion battery.

### 2. Description of Related Art

Japanese Unexamined Patent Application Publication (Translation of PCT Application) No. 2015-528640 (JP 2015-528640 A) discloses an electrolytic solution containing an ester-based solvent in an amount of 10% to 90% by weight with respect to the total weight of the non-aqueous solvent.

### SUMMARY

In general, a lithium ion battery (hereinafter, may be simply referred to as a “battery”) is a sealed system. The decomposition reaction of the electrolytic solution may be accompanied by gas generation. The internal pressure may be continuously increased due to the gas generation in the battery.

An object of the present disclosure is to alleviate an increase in internal pressure.

1. A lithium ion battery in a first aspect of the present disclosure includes the following configuration. The lithium ion battery includes a positive electrode, a negative electrode, and an electrolytic solution. The positive electrode includes a positive electrode mixture. The positive electrode mixture contains a positive electrode active material and active lithium. A mass fraction of the active lithium with respect to a total of the positive electrode active material and the active lithium is 0.25% or more. The electrolytic solution contains a solvent and a lithium salt. The solvent contains a carboxylic acid ester in a volume fraction of 40% or more.

The gas generated by the decomposition of the electrolytic solution may contain various components. In particular, the composition ratio of carbon dioxide gas tends to be high. The carbon dioxide gas may include, for example, carbon monoxide (CO) and carbon dioxide (CO₂). In the battery, carbon dioxide gas can be dissolved in a solvent (electrolytic solution). The carbon dioxide gas dissolved in the electrolytic solution can be released from the electrolytic solution, for example, in response to a temperature change or the like. In the battery, the increase in the internal pressure is considered to continue while the dissolution and release of carbon dioxide gas are repeated. In a case where the solvent contains the carboxylic acid ester in a volume fraction of 40% or more, in at least one of the positive electrode and the negative electrode, a part of the carbon dioxide gas dissolved in the electrolytic solution can be reacted with, for example, lithium (Li) or the like to be changed to a solid compound. That is, a part of the carbon dioxide gas can be fixed to the electrode. The fixed carbon dioxide gas is considered to be able to be separated from the dissolution and release cycle.

Furthermore, the positive electrode includes chemically active Li (hereinafter also referred to as “active Li”). By the presence of a specific amount or more of the active Li in the positive electrode, the fixation of carbon dioxide gas in the positive electrode can be promoted. The increase in the internal pressure is expected to be alleviated by the synergistic effect of these actions.

2. The lithium ion battery according to “1” described above may include, for example, the following configuration. The negative electrode includes a negative electrode mixture. The negative electrode mixture contains a negative electrode active material and amorphous carbon. At least a part of the surface of the negative electrode active material is coated with the amorphous carbon. A mass fraction of amorphous carbon with respect to a total of the negative electrode active material and the amorphous carbon is 0.5% to 1%.

By the presence of a specific amount of amorphous carbon on the surface of the negative electrode active material, the fixation of carbon dioxide gas in the negative electrode can be promoted. As a result, the increase in the internal pressure is expected to be further alleviated.

3. The lithium ion battery according to “1” or “2” described above may include, for example, the following configuration. A mass fraction of the active lithium with respect to the positive electrode active material is 0.25% to 0.5%. The solvent contains a carboxylic acid ester in a volume fraction of 40% to 70%.

4. The lithium ion battery according to any one of “1” to “3” described above may include, for example, the following configuration. The carboxylic acid ester is at least one selected from the group consisting of methyl propionate and methyl acetate.

5. A lithium ion battery in a second aspect of the present disclosure may include the following configuration. The lithium ion battery includes a positive electrode, a negative electrode, and an electrolytic solution. The positive electrode includes a positive electrode mixture. The positive electrode mixture contains a positive electrode active material and active lithium. A mass fraction of the active lithium with respect to a total of the positive electrode active material and the active lithium is 0.25% to 0.5%. The negative electrode includes a negative electrode mixture. The negative electrode mixture contains a negative electrode active material and amorphous carbon. At least a part of the surface of the negative electrode active material is coated with the amorphous carbon. A mass fraction of amorphous carbon with respect to a total of the negative electrode active material and the amorphous carbon is 0.5% to 1%. The electrolytic solution contains a solvent and a lithium salt. The solvent contains a carboxylic acid ester in a volume fraction of 40% to 70%. The carboxylic acid ester is at least one selected from the group consisting of methyl propionate and methyl acetate.

Hereinafter, embodiments of the present disclosure (hereinafter, may be simply referred to as “the present embodiment”) and examples of the present disclosure (hereinafter, may be simply referred to as “the present example”) will be described. Note that the present embodiment and the present example do not limit the technical scope of the present disclosure. The present embodiment and the present example are merely examples in all respects. The present embodiment and the present example are non-restrictive. The technical scope of the present disclosure includes all modifications within the meaning and scope equivalent to the description of CLAIMS. For example, extracting any configurations from the present embodiment and combining the configurations in any manner are preconceived from the first.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual view showing an example of a lithium ion battery in a present embodiment;

FIG. 2 is Table 1 showing experimental results;

FIG. 3 is Table 2 showing experimental results;

FIG. 4 is Table 3 showing experimental results;

FIG. 5 is a graph showing a relationship among a volume fraction of CAE, an active Li amount, and a cell contraction amount; and

FIG. 6 is a graph showing a relationship among a volume fraction of CAE, an amorphous coating amount, and a cell contraction amount.

### DETAILED DESCRIPTION OF EMBODIMENTS

### Main Terms

The “active Li amount” indicates the mass fraction of the active Li with respect to the total of the positive electrode active material and the active Li. The active Li amount is measured by the following procedure. First, the substance quantity (unit: mol) of lithium hydroxide (LiOH) adhering to the positive electrode active material is measured. The positive electrode active material is subjected to a water washing treatment. After water washing, the substance quantity of LiOH adhering to the positive electrode active material is measured again. The substance quantity of LiOH before water washing is subtracted from the substance quantity of LiOH after water washing to obtain the increase amount of LiOH. The increase amount (substance quantity) of LiOH is converted into the mass, and thus the mass of the active Li is obtained. The active Li amount (mass fraction) is obtained by dividing the mass of the active Li by the total mass of the positive electrode active material and the active Li.

The “amorphous coating amount” indicates the mass fraction of the amorphous carbon with respect to the total of the negative electrode active material and the amorphous carbon. The coating treatment with the amorphous carbon can be performed by the following procedure. The carbon raw material (for example, pitch) and the negative electrode active material are mixed to prepare a mixture. By subjecting the mixture to heat treatment, the carbon raw material can be converted into amorphous carbon. The mass fraction of the carbon raw material with respect to the entire mixture in the process of coating treatment is regarded as the “amorphous coating amount.”

The “carboxylic acid ester (CAE)” represents a compound derived from the condensation of a carboxylic acid and an alcohol. The CAE is distinguished from a carbonic acid ester (carbonate).

A numerical range such as “from m % to n %” includes an upper limit value and a lower limit value, unless otherwise specified. That is, “from m % to n %” indicates a numerical range of “m % or more and n % or less.” Further, “m % or more and n % or less” includes “more than m % and less than n %.” Also, “or more” and “or less” are respectively represented by inequality signs with an equal sign “≤”, “≥.” Further, “more than” and “less than” are respectively represented by inequality signs excluding an equal sign “<”, “>.” A numerical value selected from a numerical range in any manner may be adopted as a new upper limit value or lower limit value. For example, a new numerical range may be set by combining a numerical value within a numerical range with a numerical value described in another part, table, or drawing in the present specification.

### Lithium Ion Battery

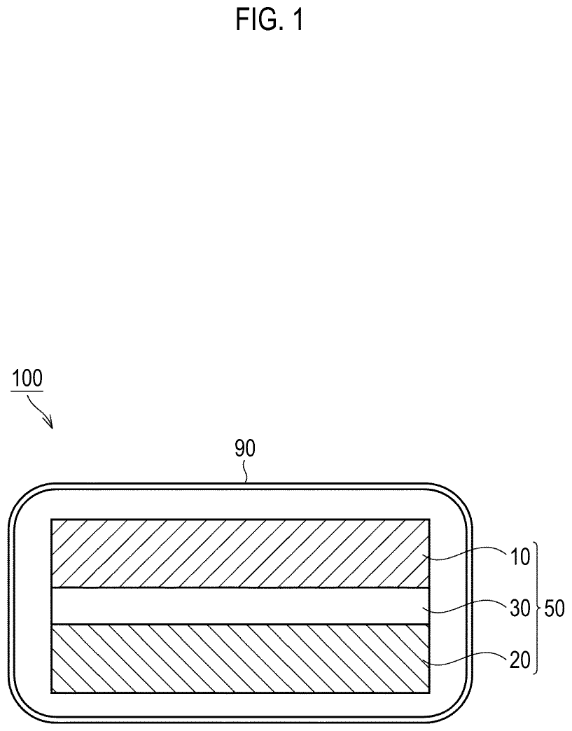

FIG. 1 is a conceptual view showing an example of a lithium ion battery in the present embodiment. A battery 100 contains a power generation element 50 and an exterior body 90. The exterior body 90 is sealed. The exterior body 90 may be, for example, a metal case, a pouch made of a metal foil laminate film, or the like. The exterior body 90 accommodates the power generation element 50 and an electrolytic solution (not shown).

### Electrolytic Solution

The electrolytic solution is a liquid electrolyte. The electrolytic solution contains a solvent and a Li salt. The Li salt is dissolved in a solvent. The concentration of the Li salt may be, for example, any of 0.5 to 2 mol/L or 1 to 1.5 mol/L. The Li salt may be, for example, at least one selected from the group consisting of LiPF₆, LiBF₄, LiClO₄, LiN(SO₂F)₂ “LiFSI”, and LiN(SO₂CF₃)₂“LiTFSI”.

The solvent contains CAE in a volume fraction of 40% or more. The solvent may contain, for example, the CAE in a volume fraction of 40% to 70%. The solvent may be formed of, for example, CAE in a volume fraction of 40% to 70% and a carbonate as the remainder. The volume fraction of the CAE may be, for example, 50% or more, or 60% or more. The CAE may have a low viscosity as compared with the carbonate. By an increase in the volume fraction of the CAE, for example, improvement of the rate characteristics is expected. The volume fraction of the CAE may be, for example, 60% or less, or 50% or less.

The CAE may be, for example, at least one selected from the group consisting of methyl formate (MF), methyl acetate (MA), methyl propionate (MP), and diethyl malonate (DEM). The CAE may include, for example, at least one selected from the group consisting of the MP and the MA.

The carbonate may include, for example, at least one selected from the group consisting of cyclic carbonates and chain carbonates. The cyclic carbonate may include, for example, at least one selected from the group consisting of ethylene carbonate (EC), propylene carbonate (PC), butylene carbonate (BC), and monofluoroethylene carbonate (FEC). The chain carbonate may include, for example, at least one selected from the group consisting of dimethyl carbonate (DMC), diethyl carbonate (DEC), and ethyl methyl carbonate (EMC).

The solvent may satisfy the following relationship, for example.

$$Va + Vb + Vc = 100 \%$$

$$20 \% \leq Va \leq 40 \% , 0 \% \leq Vb \leq 30 \% , 40 \% \leq Vc \leq 70 \%$$

Va: volume fraction of the cyclic carbonate
Vb: volume fraction of the chain carbonate
Vc: volume fraction of the CAE

The electrolytic solution may further contain any additive in addition to the solvent and the Li salt. The addition amount (mass fraction with respect to the entire electrolytic solution) may be, for example, 0.01% to 5%, or 0.1% to 1%. The additive may include, for example, vinylene carbonate (VC), LiB(C₂O₄)₂ “LiBOB”, and the like.

### Power Generation Element

The power generation element 50 may also be referred to as, for example, an “electrode body” or the like. The power generation element 50 contains a positive electrode 10 and a negative electrode 20. The power generation element 50 may further contain a separator 30. The power generation element 50 may have any form. The power generation element 50 may be, for example, either a wound type or a laminated type.

### Positive Electrode

The positive electrode 10 may be, for example, in a sheet shape. The positive electrode 10 may include, for example, a positive electrode current collector and a positive electrode mixture layer. The positive electrode current collector supports a positive electrode mixture layer. The positive electrode current collector may contain, for example, an aluminum (Al) foil or the like. The positive electrode mixture layer may be made of a positive electrode mixture. The positive electrode mixture contains a positive electrode active material and active Li. The active Li amount is 0.25% or more. The active Li amount may be, for example, 0.5% or more, 0.75% or more, or 1% or more. The active Li amount may be, for example, 2% or less, 1% or less, 0.75% or less, or 0.5% or less.

The positive electrode active material may be, for example, a particle group (powder). D50 of the positive electrode active material may be, for example, 1 μm to 30 μm, or 5 μm to 15 μm. “D50” indicates a particle size at which the cumulation in the volume-based particle size distribution (cumulative distribution) reaches 50%. The particle size distribution can be measured by a laser diffraction method. The positive electrode active material may include any component. The positive electrode active material may include, for example, at least one selected from the group consisting of LiCoO₂, LiNiO₂, LiMnO₂, LiMn₂O₄, Li(NiCoMn)O₂, Li(NiCoAl)O₂, and LiFePO₄. For example, in “Li(NiCoMn)O₂”, “(NiCoMn)” indicates that the total of the composition ratios in the parentheses is 1. As long as the total is 1, the individual components may be in any amounts. The Li(NiCoMn)O₂ may contain, for example, LiNi_{1/3}Co_{1/3}Mn_{1/3}O₂, LiNi_{0.5}Co_{0.2}Mn_{0.3}O₂, LiNi_{0.8}Co_{0.1}Mn_{0.1}O₂, or the like. Hereinafter, LiNi_{1/3}Co_{1/3}Mn_{1/3}O₂ may be abbreviated as “NCM”.

The positive electrode mixture may further contain, for example, a conductive material, a binder, and the like in addition to the positive electrode active material and the active Li. The conductive material may include, for example, at least one selected from the group consisting of carbon black (CB), vapor grown carbon fibers, carbon nanotubes, and graphene flakes. The blending amount of the conductive material may be, for example, 0.1 to 10 parts by mass with respect to 100 parts by mass of the positive electrode active material.

The binder may include, for example, at least one selected from the group consisting of polyvinylidene fluoride (PVdF), polytetrafluoroethylene (PTFE), vinylidene fluoride-hexafluoropropylene copolymer (PVdF-HFP), and polyacrylic acid (PAA). The blending amount of the binder may be, for example, 0.1 to 10 parts by mass with respect to 100 parts by mass of the positive electrode active material.

### Negative Electrode

The negative electrode 20 may be, for example, in a sheet shape. The negative electrode 20 may include, for example, a negative electrode current collector and a negative electrode mixture layer. The negative electrode current collector supports a negative electrode mixture layer. The negative electrode current collector may include, for example, a copper (Cu) foil. The negative electrode mixture layer may be made of a negative electrode mixture. The negative electrode mixture contains a negative electrode active material. The negative electrode active material may be a particle group, for example. D50 of the negative electrode active material may be, for example, 1 μm to 30 μm, or 5 μm to 15 μm. The negative electrode active material may contain any component. The negative electrode active material may include, for example, at least one selected from the group consisting of natural graphite, artificial graphite, silicon (Si), silicon oxide (SiO), a Si-based alloy, a Si—C composite material, tin, tin oxide, and lithium titanate. The “Si—C composite material” may include, for example, composite particles. The composite particle may include, for example, porous carbon particles. Si particles may be supported in pores of the porous carbon particles.

The negative electrode mixture may further contain amorphous carbon in addition to the negative electrode active material. The amorphous carbon has a lower crystallinity as compared with graphite (crystalline carbon). The R value of the amorphous carbon may be, for example, 0.5 or more, 1.0 or more, or 1.5 or more. The R value is obtained by the following equation. As the R value is larger, the crystallinity is considered to be lower.

$$R value = {I}_{1360} / {I}_{1580}$$

I₁₃₆₀: intensity of a peak (D band) near 1360 cm⁻¹ in the Raman spectrum of the target object
I₁₅₈₀: intensity of a peak (G band) near 1580 cm⁻¹ in the Raman spectrum of the target object

At least a part of the surface of the negative electrode active material may be coated with the amorphous carbon. The amorphous carbon may form a coating layer. The thickness of the coating layer may be, for example, 5 to 10 nm. The amorphous coating amount may be, for example, 0.25% or more, 0.5% or more, or 1.0% or more. The amorphous coating amount may be, for example, 1.5% or less, 1% or less, or 0.5% or less.

The negative electrode mixture may further contain, for example, a binder and the like in addition to the negative electrode active material and the amorphous carbon. The binder may include, for example, at least one selected from the group consisting of styrene-butadiene rubber (SBR), carboxymethyl cellulose (CMC), polyimide (PI), and polyamidoimide (PAI). The blending amount of the binder may be, for example, 0.1 to 10 parts by mass with respect to 100 parts by mass of the negative electrode active material.

### Separator

The separator 30 is disposed between the positive electrode 10 and the negative electrode 20. The separator 30 separates the positive electrode 10 from the negative electrode 20. The separator 30 may include, for example, a porous film and the like. The separator 30 may have, for example, a Gurley value of 200 to 400 seconds/100 mL. The “Gurley value” can be measured by a Gurley test method. The separator 30 may have a multilayer structure, for example. The multilayer structure may be formed, for example, by stacking a polypropylene (PP) layer, a polyethylene (PE) layer, and a PP layer in this order.

### Production of Test Cell

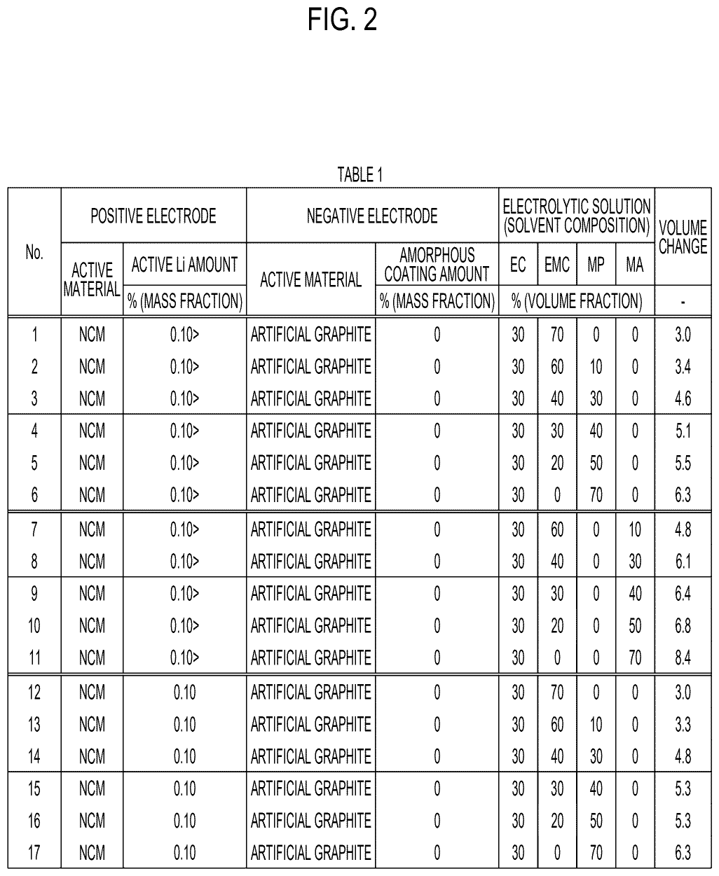

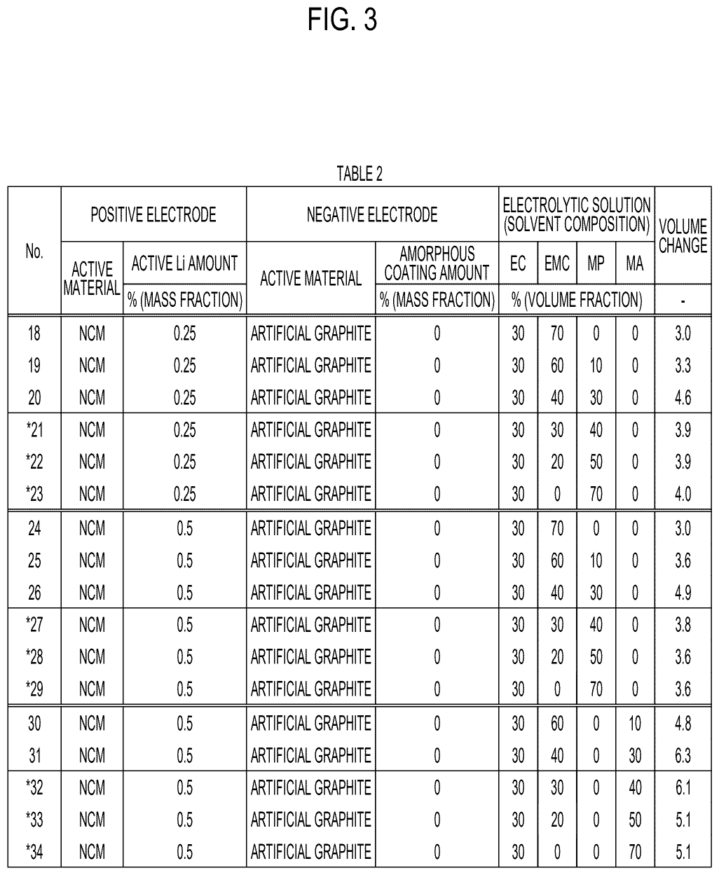

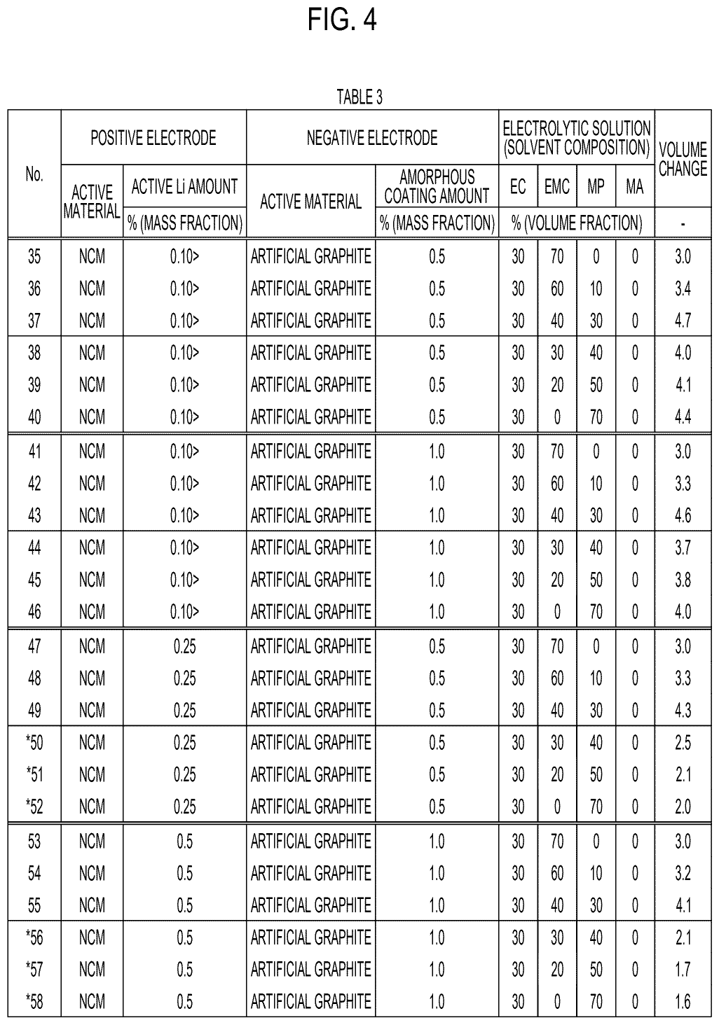

FIG. 2 is Table 1 showing experimental results. FIG. 3 is Table 2 showing experimental results. FIG. 4 is Table 3 showing experimental results. The cells (lithium ion batteries) according to No. 1 to No. 58 were produced by the following procedure.

### Production of Positive Electrode

The following materials were prepared.
Positive electrode active material: NCM (active Li amount: see FIGS. 2 to 4)
Conductive material: CB
Binder: PVdF
Dispersion medium: N-methyl-2-pyrrolidone (NMP)
Positive electrode current collector: Al foil

A slurry was prepared by mixing NCM, CB, PVdF, and NMP. The blending ratio of the solid content was “NCM/CB/PVdF=87/10/3 (mass ratio)”. The surface of the positive electrode current collector was coated with the slurry to form a positive electrode mixture layer. The positive electrode was produced by compressing the positive electrode mixture layer.

### Production of Negative Electrode

The following materials were prepared.
Negative electrode active material: artificial graphite (D50=15 μm, amorphous coating amount: see FIGS. 2 to 4)
Binder: SBR, CMC
Dispersion medium: water
Negative electrode current collector: Cu foil

Graphite, CMC, SBR, and water were mixed to prepare a slurry. The blending ratio of the solid content was “graphite/CMC/SBR=98/1/1 (mass ratio)”. The surface of the negative electrode current collector was coated with the slurry to form a negative electrode mixture layer. The basis weight of the negative electrode mixture layer was adjusted such that the ratio of the negative electrode capacity to the positive electrode capacity is 1.1. The negative electrode was produced by compressing the negative electrode mixture layer.

### Assembly

The following materials were prepared.
Separator three-layer structure (PP layer/PE layer/PP layer), Gurley value=300 seconds/100 mL
Exterior body: pouch made of Al laminated film
Electrolytic solution: LiPF₆ (concentration=1 mol/L), solvent composition (see FIGS. 2 to 4)

A power generation element was formed by laminating a positive electrode, a separator, and a negative electrode. The power generation element was accommodated in the exterior body. An electrolytic solution was injected into the exterior body. After the electrolytic solution was injected, the exterior body was sealed to produce a cell.

### Activation Treatment

The following cycle of constant current charging and constant current discharging was repeated three times in a constant temperature bath (set temperature: 25° C.). “C” is a symbol representing an hour rate of a current. The current of 1 C flows through the rated capacity of the cell in one hour.
Constant current charging: current=0.1 C, cut voltage=4.3 V
Constant current discharging: current=0.3 C, cut voltage=3 V

### Capacity Measurement

The initial capacity (initial discharge capacity) was measured by the constant current-constant voltage charging and the constant current discharging, which will be described.
Constant current-constant voltage charging: current=0.1 C, upper limit voltage=4.3, cut current=0.02 C
Constant current discharging: current=0.2 C, cut voltage=3 V

### Storage Test

The initial volume of the cell was measured by the Archimedes method. The voltage of the cell was adjusted to 4.3 V by constant current-constant voltage charging (current=0.1 C, upper limit voltage=4.3 V) in a constant temperature bath (set temperature: 25° C.). After the adjustment of the voltage, the cell was allowed to stand for 100 days in a constant temperature bath (set temperature: 60° C.). After 100 days, the cell was discharged by constant current discharging (current=0.2 C, cut voltage=3 V) in a constant temperature bath (set temperature: 25° C.). After the discharging, the volume of the cell after storage was measured by the Archimedes method. The “volume change (dimensionless quantity)” was obtained by dividing the volume after storage by the initial volume. As the value shown in the “volume change” item in FIGS. 2 to 4 is lower, the increase in the internal pressure is considered to be more alleviated.

### Results

In the tables of FIGS. 2 to 4, the cells that satisfy the following conditions (A) and (B) show a tendency to have a small volume change. In the tables, in “No.” of the cells satisfying the following conditions (A) and (B), the “*” mark is placed, for example, as “No.*21”.
(A) a volume fraction of the CAE (MP, MA) in the electrolytic solution is 40% or more.
(B) an active Li amount in the positive electrode is 0.25% or more.

In the tables, the cells that satisfy the following condition (C) in addition to the above-described conditions (A) and (B) show a tendency to have a further smaller volume change.
(C) an amorphous coating amount in the negative electrode is 0.5% to 1%.

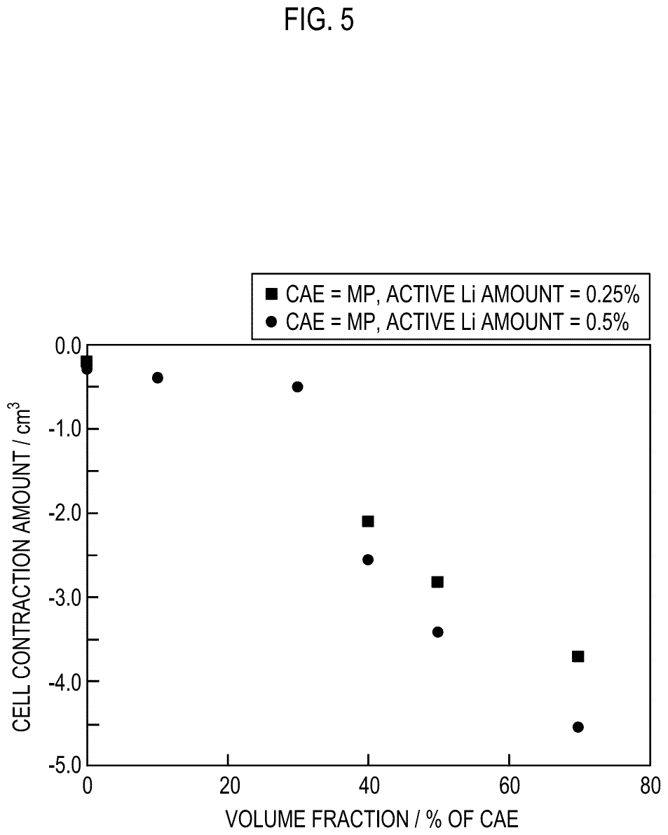

FIG. 5 is a graph showing a relationship among a volume fraction of CAE, an active Li amount, and a cell contraction amount. The cell contraction amount is measured by the following procedure. After the end of the storage test, the cell is allowed to stand for 7 days in a constant temperature bath (set temperature: 25° C.). After 7 days, the volume of the cell after standing is measured by the Archimedes method. The cell contraction amount (unit: cm³) is obtained by subtracting the volume after storage from the volume after standing. The cell contraction amount usually takes a negative value. As the absolute value of the cell contraction amount is larger, the carbon dioxide gas generated during the storage test is considered to be easily fixed to the electrode. In a case where the volume fraction of the CAE is 40% or more, the cell contraction amount (absolute value) is rapidly increased. As the active Li amount increases, the cell contraction amount (absolute value) tends to further increase.

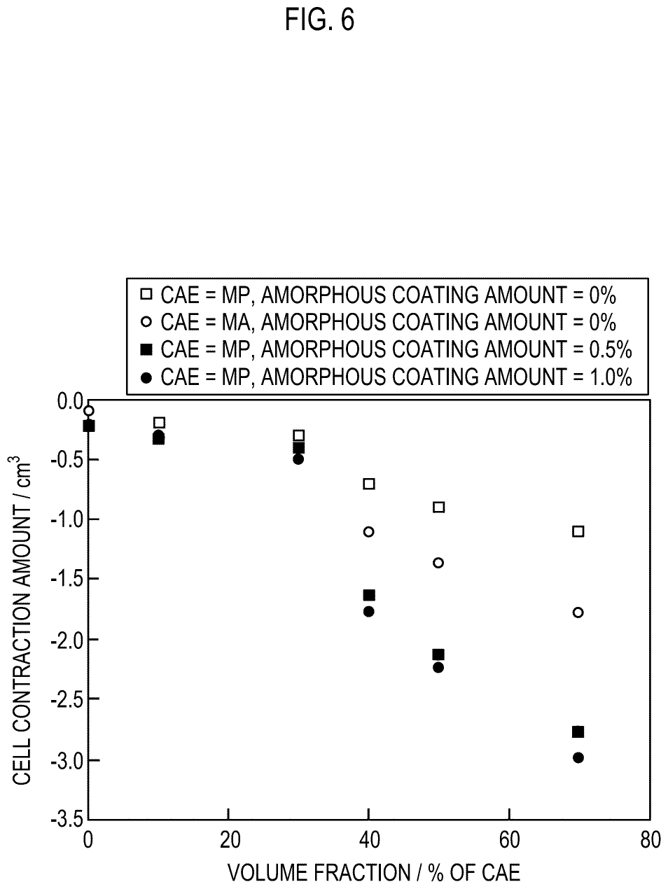

FIG. 6 is a graph showing a relationship among the volume fraction of CAE, an amorphous coating amount, and a cell contraction amount. In a case where the volume fraction of the CAE is 40% or more, the cell contraction amount (absolute value) is rapidly increased. The amorphous coating is applied to the negative electrode active material, and thus the cell contraction amount (absolute value) tends to further increase.

What is claimed is:

1. A lithium ion battery comprising:
a positive electrode;
a negative electrode; and
an electrolytic solution, wherein
the positive electrode includes a positive electrode mixture,
the positive electrode mixture contains a positive electrode active material and active lithium,
a mass fraction of the active lithium with respect to a total of the positive electrode active material and the active lithium is 0.25% or more,
the electrolytic solution contains a solvent and a lithium salt, and
the solvent contains a carboxylic acid ester in a volume fraction of 40% or more.

2. The lithium ion battery according to claim 1, wherein:
the negative electrode includes a negative electrode mixture;
the negative electrode mixture contains a negative electrode active material and amorphous carbon;
at least a part of a surface of the negative electrode active material is coated with the amorphous carbon; and
a mass fraction of the amorphous carbon with respect to a total of the negative electrode active material and the amorphous carbon is 0.5% to 1%.

3. The lithium ion battery according to claim 1, wherein:
a mass fraction of the active lithium with respect to the positive electrode active material is 0.25% to 0.5%; and
the solvent contains the carboxylic acid ester in a volume fraction of 40% to 70%.

4. The lithium ion battery according to claim 1, wherein the carboxylic acid ester is at least one selected from the group consisting of methyl propionate and methyl acetate.

5. A lithium ion battery comprising:
a positive electrode;
a negative electrode; and
an electrolytic solution, wherein
the positive electrode includes a positive electrode mixture,
the positive electrode mixture contains a positive electrode active material and active lithium,
a mass fraction of the active lithium with respect to a total of the positive electrode active material and the active lithium is 0.25% to 0.5%,
the negative electrode includes a negative electrode mixture,
the negative electrode mixture contains a negative electrode active material and amorphous carbon,
at least a part of a surface of the negative electrode active material is coated with the amorphous carbon,
a mass fraction of the amorphous carbon with respect to a total of the negative electrode active material and the amorphous carbon is 0.5% to 1%,
the electrolytic solution contains a solvent and a lithium salt,
the solvent contains a carboxylic acid ester in a volume fraction of 40% to 70%, and
the carboxylic acid ester is at least one selected from the group consisting of methyl propionate and methyl acetate.
